(19) United States
(12) Patent Application Publication
(10) Pub. No.: US 2008/0233232 A1
(43) Pub. Date: Sep. 25, 2008

(54) Food Additive For Supplying Mineral Nutrients

(75) Inventor: Jobst Lahrsow, Tauberbischofsheim (DE)

Correspondence Address: BROWDY AND NEIMARK, P.L.L.C.;624 NINTH STREET, NW, SUITE 300, WASHINGTON, DC, 20001-5303, US

(73) Assignee: MEDERER SUSSWARENVERTRIEBS, Furth (DE)

(21) Appl. No.: 12/064,803

(22) PCT Filed: Aug. 23, 2006
(86) PCT No.: PCT/DE2006/001475

§ 371 Date: Feb. 25, 2008

(30) Foreign Application Priority Data
Aug. 25, 2005 (DE) 10 2005 040 423.5

(51) Int. Cl. A23G 4/12; A23L 1/304

(52) U.S. Cl. 426/3; 426/648

(57) ABSTRACT

The invention relates to a food additive as a concentrated additive for supplying the human metabolism with mineral substances. The mineral substances are components of a salt-hydrate melt in an ionized form, and the salt-hydrate melt is a salt-water system, whereby the water content corresponds to the coordination number of the most hydrated ion.

The present invention relates to a food additive for supplying the human metabolism with mineral nutrients.

For the human body, mineral nutrients are existentially required non-organic nutrients. Because the organism itself is unable to produce them, they must be supplied with the food we consume. Just like vitamins, however, mineral nutrients are not a source of energy, which means that they are basically not involved in the energy metabolism.

Most mineral nutrients are so-called building or regulator substances. The building substances include calcium, phosphorus and magnesium, and the regulator substances include iodine, sodium, potassium, iron and chloride. Only a few mineral nutrients exhibit both properties together. Phosphorus, for example, plays a role in building bones and teeth, and at the same time also in regulating the acid/alkaline balance.

In the human organism, mineral nutrients are an indispensable component for many functions. For the development of bodily substances, such as bones, teeth and muscles, the mineral nutrients provide strength and resilience. Essential necessary properties of body fluids are influenced by dissolved mineral nutrients as electrolytes. This includes, for example, maintaining the osmotic pressure.

Mineral nutrients are also essential components of organic compounds in the body. Iodine is a component of the thyroid hormone. Cobalt is contained in vitamin B12, the blood coloring agent hemoglobin requires iron.

Based on the recommendations of the German Nutrition Society (Deutsche Gesellschaft für Ernährung), young people and adults, depending on their age and gender, need at least 1000 to 1200 mg calcium per day, 700 to 1250 mg phosphorus, 350 to 400 mg magnesium, 12 to 15 mg iron, 150 to 200 mg iodine, 7 to 10 mg zinc and other mineral nutrients, so-called trace elements, in smaller amounts. The human organism has adapted, in the course of its development over thousands of generations, to a diet consisting of at least ⅔ plant components. A recent study, which was performed by K. Gedrich and G. Karg at Munich University of Technology in Germany, revealed that the actual diet in Germany drastically deviates from an optimized nutrition in terms of an adequate mineral supply: compared to the recommended amount, the actual consumption of fruit and vegetables has dropped to half, and for grain products and potatoes to ⅔. In women, the consumption of vegetables has even dropped to ⅓, whereas the consumption of meat, fish and eggs, on the other hand, has increased to 1.3 times the recommended amount. Their place has been taken by foods that are prepared by processing in the kitchen or by industrial processing methods. These methods lead to, sometimes significant, losses of mineral nutrients and trace elements. This results in a drastic reduction in the average supply of the population with mineral nutrients.

Numerous food additives are known from the prior art that are intended to remedy the above-described deficiency. They have various shortcomings, however. In accordance with patent document DE 103 49 050 A 1, bondable calcium and phosphate is to be introduced into food products, such as fruit-flavored gummi candy, gelatin products, or other candy. The shortcoming lies in that when the recommended amounts of mineral-nutrient-containing additives are added, they precipitate during the manufacturing process as crystals and cloud the product in an unacceptable manner. If the admixtures are evaporated by concentration to the amount at which crystals no longer form, the mineral-nutrient content is so small that that the desired effect drops to a nearly insignificant level.

In the above-mentioned method, the problem of the undesirable crystallization can be reduced in such a way that a reactive calcium donor from specified compounds or mixtures is used, to which acids with different degrees of calcium complexation can additionally be added. This entails the shortcoming, however, that an excessively high water content in the solution again limits the attainable concentration of calcium and thus again reduces the effectiveness to an insignificant degree.

An alternative proposed solution is described by Jarcho in U.S. Pat. No. 4,097,935. He proposes an oversaturated solution of hydroxyl apatite as a mouthwash. Here, too, the attainable concentration is so low that a desired effect can be attained only with extremely prolonged and unrealistically frequent rinsing.

In U.S. Pat. No. 4,080,440, Digiulio describes a metastable solution of calcium and phosphate at a low pH. The anticipated mechanism of action is that, after an increase in the pH, calcium and phosphate will precipitate in the demineralized pores of the tooth enamel, especially together with the catalytically acting fluoride ions. The danger here is that the tooth enamel will already become demineralized by the low pH prior to the intended effect and tissue damage will result.

With U.S. Pat. No. 4,606,912, Rudy attempts the use of an aqueous solution with a calcium ion source and a chelating agent for calcium ions. Because of the difficulty of controlling the chelating agent, this is an impractical method, however.

In different variants, Tung (U.S. Pat. Nos. 5,037,639 and 5,268,167 and 5,437,857, as well as 5,460,803) proposes a powder that contains calcium salts, phosphates and carbonates. After dissolving in the saliva, this powder precipitates an amorphous calcium phosphate. Its stability, however, is problematic.

All in all, the example of the remineralization of tooth enamel demonstrates that significant problems with additives for the supply of mineral nutrients have not been solved. The three most significant shortcomings in the discussed example are as follows:
the concentration of calcium ions and phosphate ions that was actually achieved is too small for an effective action, or
the solution is too watery and consequently largely ineffective, or
the pH, which significantly deviates from the physiological pH of 4.5, damages the mucus membranes of the mouth, throat, stomach and digestive tract, and/or makes it vastly more difficult to work into food products.

The invention has made it its objective to provide an adequate supply of mineral nutrients and trace elements, in such a way that food additives are created that contain these mineral nutrients in an easily resorbable form.

This object is met in such a way that the mineral nutrients are a component of a salt hydrate melt in an ionized form, wherein the salt hydrate melt is a salt-water-system and its water content corresponds to the coordination number of the most hydrated ion.

It is known that the coordination number is the number of closest adjacent ions surrounding the ion and that the hydration is the attachment of H₂O to the ion.

This food additive has numerous advantages. Based on this principle, nearly all mineral nutrients and trace elements that are needed by the human organism are suppliable, specifically in an ionized form so that they can be particularly easily processed by the organism. For the processing in food production, the most important benefits are that the salt hydrate melt in its amorphously solidified form can be stored for extended periods of time without becoming unstable, that it can easily be adapted in its viscosity to the production process of the specific food product by either adding a small quantity of water and/or changing the temperature. Because two parameters are available for adjusting the viscosity, an adaptation to processes with a specific temperature or processes where the viscosity is critical, does not pose a problem.

For combining an inventive food additive with other food products it is advantageous that a multiplicity of organic acids, such as gluconic acid, lactic acid, citric acid, acetic acid, malic acid, fumaric acid, valeric acid, ascorbic acid, cysteine, glutaric acid or other acidifiers that are suitable for food products, as well as their salts, can be used in the production. It is also advantageous that, in an inventive variant, inorganic acid radicals, i.e., for example chlorides, sulphates, phosphates, fluorides, carbonates, or their partially esterified derivatives, can be used. This creates the advantage that, in the case of salts with an inorganic acid radical, for example chlorides, the acid radical exhibits a low molecular weight. It is therefore possible to attain a very high weight percentage of cations in the finished product. By using chlorides, for example, the weight percentage of cations in the final product can be noticeably increased while, at the same time, maintaining the viscosity. The maximum weight percentage of cations in the total weight of the finished products is largely determined by the molecular weight and valency of the anions. Different maximum theoretical cation percentages are obtained in dependence upon the composition of the salt mixture. If the three salts CaA₁, CaA₂ and CaA₃ with the molecular weights M₁, M₂ and M₃ are mixed in the molecular percentages x₁, x₂ and X₃, wherein x₁+x₂+x₃=1, the maximum molar content of Ca is obtained as follows:

Ca_{max.}=1/(x₁*M₁+x₂*M₂+x₃*M₃)

The inventive product can be produced and processed with a mineral-nutrient content of 10% to 95% of the maximally possible mineral-nutrient content calculated according to the above formula. By slightly varying the water content, the viscosity can be varied within a wide range.

It is advantageous that the desired pH of the salt hydrate melt can be predetermined by selecting the appropriate additives. For foods in a physiological range of around 6.5 to 7, melts with salts of inorganic and organic acids are suitable. For foods with a low (acidic) pH, salt hydrate melts with an excess of acids can be produced. They are suitable as an additive for tart dishes or candy. Acidic salt hydrate melts even make it possible to admix mineral nutrients to the sugar melt of hard candy; chewable compounds made from gelatin and other thickening agents can likewise be improved with the addition of mineral nutrients.

Examples for physiologically neutral melts are: calcium lactate and calcium gluconate or expanded by magnesium lactate. To furnish acidic melts with calcium, calcium lactate can be acidified with gluconic acid. Depending on the desired flavor of the food product, malic acid or citric acid may be added, or malic acid together with citric acid, as well as other approved acidifiers. To furnish magnesium, the melt of gluconic acid and calcium lactate is enriched with magnesium salts of, e.g., acetic acid, gluconic acid, lactic acid, or also hydrochloric acid. A practical example consists of sour chewable compounds, such as fruit-flavored gummi candy, in which the salt hydrate melt may be a sour mixture of calcium gluconate, calcium lactate, calcium malate, as well as calcium citrate.

An additional advantage of the inventive food additives is that the flavor of the product can be influenced. Calcium lactates generate a slightly bitter taste and are thus suitable for soft drinks, mixed drinks, puddings and dishes with a bitter-almond flavor, or bitter types of beer outside of the German beer purity regulations. A strongly bitter taste is effected by calcium chloride or magnesium chloride. A slightly sweet flavor with a slightly bitter aftertaste is achieved with a component of calcium acetate; suitable accordingly, for example, for use in orange marmalade, candy, and fruit juice beverages similar to Bitter Lemon. For applications in which it is not advantageous to influence the flavor, the flavorless magnesium or calcium gluconate will be predominant. In applications in which a “bitter” type of flavor is either welcome, or in which it can be composed into a new flavor experience or masked with the use of suitable aromas, the inventive embodiment will find application in which salts of the inorganic acid are used as the cation source. The option to use, e.g., the strongly bitter tasting salts magnesium chloride and calcium chloride, has the advantage that comparatively very high weight percentages of the mineral nutrients can be admixed. This is very advantageous particularly for calcium chloride, since—as mentioned above—calcium is the mineral of which the human organism requires the largest amount.

The human organism of a grown man contains approximately 1 kg of calcium. Of this amount, 99.9% are stored in the teeth and bones. To build and maintain them, calcium is constantly required, as mentioned above, depending on gender and age, between 1000 and 1200 mg per day as the minimum value.

In a statistically relevant study it was determined that the daily calcium intake of ⅔ of the adults in Germany is less than 800 mg per day. The decalcification of the bones (osteoporosis) and teeth (dental caries) is attributable to that, among other factors.

Likewise, in the muscles, a lack of calcium can lead to shaking and cramps during intense work-outs. In the advanced stage, an increased excitability of the nervous system occurs, and complaints also include muscular contractions (tetanie) and tactile hallucinations, such as prickling or numbness, or a sensation of ants crawling over one's skin (paraesthesias). From these deficiency symptoms it becomes clear that calcium, among other factors, is responsible for the electric action potentials of muscles and nerves.

In the blood circulation calcium is important as well. Here, it acts as the so-called coagulation factor IV.

These above-mentioned deficiency symptoms can be prevented with an adequate supply of calcium ions.

A correction by means of a food additive is advantageous, also because there are no known problems from overdosing. The human metabolism will absorb only the amount of calcium ions that is required for its function. Calcium ions that are present beyond that amount are eliminated naturally by the body. Only in the case of extreme overdoses in combination with a genetic predisposition have formations of kidney stones been observed in a few, rare cases. Generally, however, this effect is linked to an extreme over-consumption, which can be recognized and stopped in time.

An additional advantageous effect of calcium as a food additive is the so-called remineralization of the teeth: after the consumption of fermentable carbohydrates the bacteria of the dental plaque increase their production of acids. This causes the pH in the saliva to decrease in the area around the teeth.

Normally, i.e., at a pH between pH 6 and pH 7, the saliva is always over-saturated with a so-called hydroxyl-apatite phase. This dissolved material repairs defects in the enamel, such as cases of initial demineralization or hairline cracks.

If over-acidification causes a drop in pH below 5.5, the saliva enters a state of undersaturation and hydroxyl apatite is removed from the tooth enamel (demineralization). In the process, pores develop in the tooth enamel, which, in the advanced stage, grow into dental caries.

As soon as the pH of the saliva once again rises above a pH of 5.5, the saturation limit of hydroxyl apatite in the saliva is once again exceeded, so that the pores that were caused by the acid attack are re-filled by the dissolved mineral in the saliva (remineralization).

If, due to an excessively frequent consumption of sugar-containing dishes and/or due to insufficient removal of the plaques, the effects of the demineralization phases outweigh those of the remineralization phases, mineral substance is continually leached from the tooth enamel. The pores deepen and a dental caries lesion develops. To stop this development, it is helpful to provide an additional supply of calcium ions to the saliva during the demineralization phase. By increasing the calcium concentration in the saliva, the concentration gradient between the saliva and the plaques becomes smaller. This has the effect that less or no calcium diffuses from the plaques into the saliva. The diffusion flow may even be reversed and contribute to a forced remineralization of the tooth enamel.

An increased calcium concentration in the plaques provides additional advantages. Due to the typical pH profiles in the dental plaques over time after the consumption of sugar-containing fare, the remineralization of the tooth enamel can start at the bottom of the pore if the calcium concentration is adequate, under the catalytic effect of fluoride. In the case of a pH that is constant over time, the remineralization, especially in the case of an increased fluoride concentration, is essentially limited to the outermost surface layer of 20 to 100 μm thickness. Under unfavorable circumstances, this can result in the formation of a cap over the pore.

An additional inventive advantage are quantities of mineral nutrients that have not been transported to this extent up to now, as practicable additives to toothpaste, mouthwashes, other oral hygiene articles, lipsticks, other ointments or liquids to be applied to the lips, or medicinal drugs for oral or rectal administration, and other pills, capsules or suppositories. Here, too, new options are opened up due to the fact that the viscosity of the food additive is easily adjusted with the addition of water, and established and proven production methods therefore do not need to be changed at all or only insignificantly. The known halitosis-preventing action of zinc could easily be introduced into toothpaste and mouthwashes. Additionally, salt hydrate melt has a very long shelf life. From this stability follow new possibilities for adding mineral nutrients to human food and the human drinking water and beverage supply. The invention proposes, among other things, to coat the inside of drinking straws with inventive salt hydrate melts. The beverage that flows past this coating causes a continuous reduction of the mineral-containing salt hydrate melt that is deposited on the inside layer. In this manner, the drinking straw becomes a food product, of course, which needs to be labeled accordingly and marked with the proper expiration date.

In a continuation of this idea, the interior surfaces of drinking water dispensers, drinking-water purification apparatuses, or machines for the production of ice-cubes, can be coated as well.

Additional advantageous applications consist of the admixture to all types of beverages. The spectrum starts with beverages with a preferably low calorie content, which serve to supply fluids, with the above-mentioned possibility of being able to not only admix mineral nutrients, but to also adjust the flavor. In the case of these beverages, the addition of inventive food additives does not lead to an undesired increase in the calorie content.

At the other end of the possible spectrum are calorie-containing beverages, such a milk, cocoa, wine, or beer. Here, the inventive food additive is of interest due to the fact that, in a flavorless variant, it leaves the essential character of the beverage untouched, but carries the added marketing argument of an increased mineral-nutrient content.

An additional inventive continuation of this idea is that a mineral-nutrient-containing salt hydrate melt is admixed to the beverage or drinking water from a reservoir via a tubing connection in the above-mentioned or similar machines.

The consistent application of this principle opens up the possibility of utilizing public drinking water supplies to supply the entire population with mineral nutrients by admixing inventive salt hydrate melts in a targeted manner.

Of great interest is the possibility of being able to noticeably enhance the status of non-essential foods, such a filled chocolates, liquorice candy, cakes, cookies, jam, French fries and hamburgers in advertisement because of an increased mineral content.

In the text that follows, additional details and characteristics of the invention will be explained in more detail with the aid of examples. The depicted examples are not intended to limit the invention, they are solely intended to explain it. The schematic illustrations are as follows:

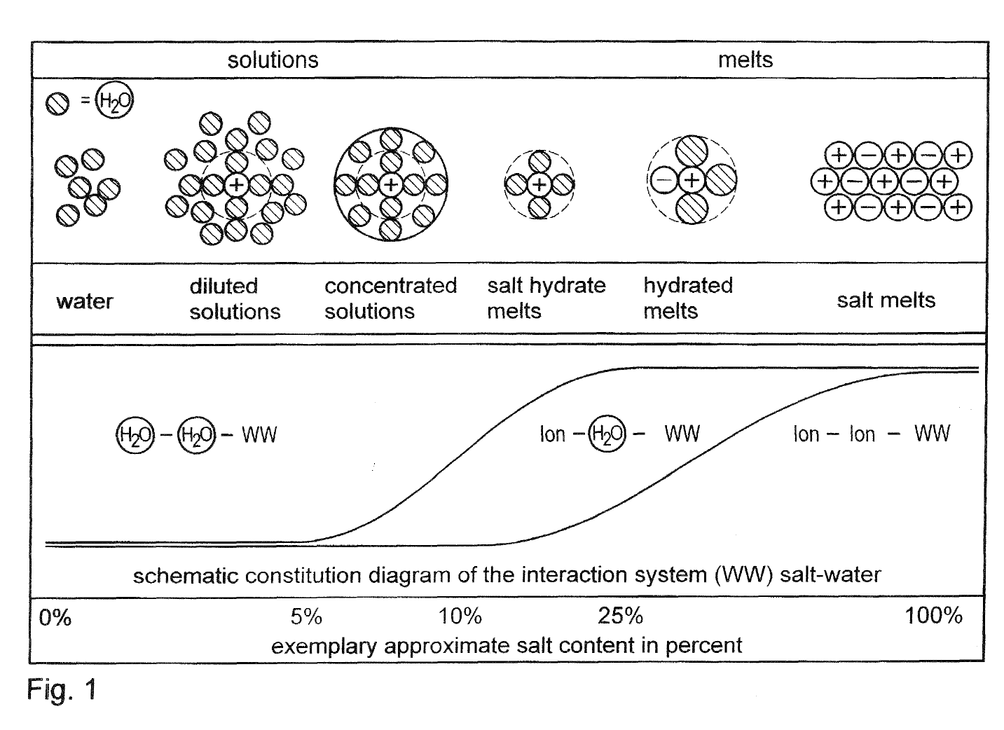

FIG. 1 is a tabulated illustration of the coordination and interaction in the salt-water-system;

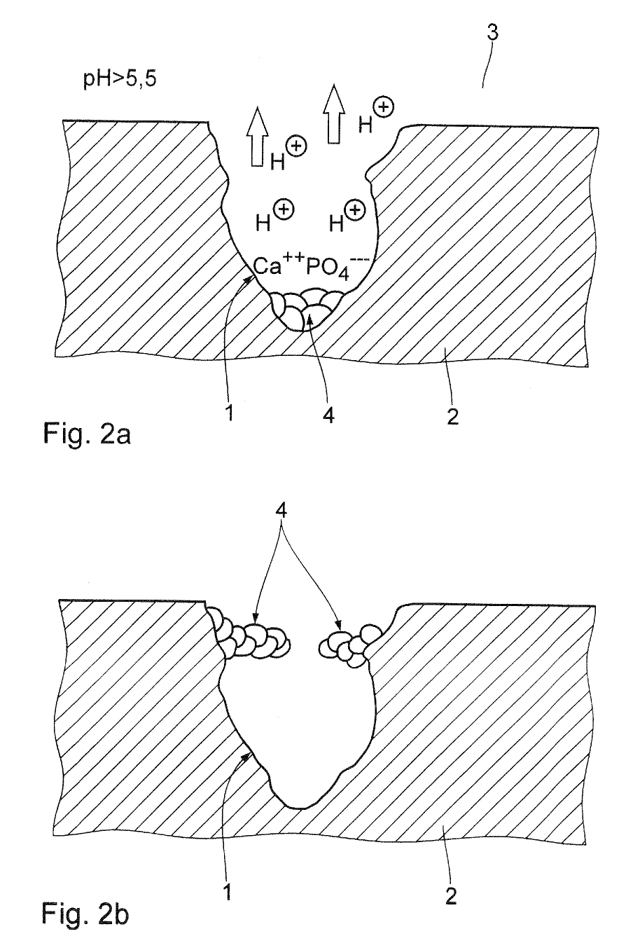

FIG. 2 shows the remineralization of a pore in the tooth enamel.

Specifically, the figures depict the following:

FIG. 1 outlines the schematic structure of salt hydrate melts in a classification ranging from pure water, to diluted salt solutions, to hydrated salt melts.

Across the top, the structures of the molecular arrangement are shown. The water molecules are represented by H₂O, the cations are represented by a circle with a plus sign, and the anions by a circle with a minus sign.

In the line below that, the designations are set down, starting from pure water, to solutions, and ending with concentrated salt melts.

In the fourth line, three different interactions are denoted, and their respective estimated part in the total interaction effect.

In the last line, a number represents the respective salt content.

The columns in FIG. 1 illustrate four characteristic stages of a salt-water-system:

On the left, starting from pure water, the structure of a diluted solution with a salt content of up to 5% has been entered in the Figure. The specific interaction (WW) in this case is directed predominantly at the water.

The third column of the table shows the structure of a concentrated salt solution with a salt content of up to 10%. Here, in addition to the water-water interactions, the ion-ion interactions are starting to become very noticeable. As the other extreme, the far right column of the table describes a salt content of 100%. Water is no longer present even in the form of constitutional water. This is a pure salt melt, in which interactions occur exclusively between the salt ions.

In the fourth column from the left, a salt hydrate melt is characterized as follows: in the top line a cation as the structure is completely surrounded by water molecules. The number of four water molecules exemplifies the coordination number four of the cation. As a result of the “thinner” hydrate sheath, the shielding of the ions by the water molecules decreases, which is symbolized by a single, dashed circle in the structure. Consequently, the interaction between the ions increasingly becomes noticeable. In the schematic constitutional diagram, the interaction between the ion and water molecules is depicted as the main interaction for a salt hydrate melt. It is apparent (at the bottom of the fourth column), that a salt hydrate melt also has a degree of interaction between the ions. This section of the figure describes a very significant feature of salt hydrate melts, name the occurrence of three different types of interaction:
Interaction between water molecules
Interaction between the ion and the water molecules surrounding it
interaction between the ions.

The salt content of a salt hydrate melt is denoted in the present example as 10 to 25% (mol %).

In FIG. 2, two cross-sections through a pore 1 are drawn in the tooth enamel 2. In the upper example, FIG. 2a, the pH in the saliva of the oral cavity 3 has dropped (due to the fermentation of carbohydrates) below pH 5.5. The resulting imbalance of hydroxyl apatite in the saliva 3 attracts hydroxyl-apatite ions, indicated in FIG. 2a with H⁺. In the absence of other sources, the lacking hydroxyl apatite would be removed from the tooth enamel 2. In the depicted configuration with a pH profile that varies over time, in conjunction with an over-supply of calcium phosphate in the oral cavity, the hydroxyl-apatite undersaturation is compensated by the calcium phosphate in the saliva under the catalytic action of fluoride. From FIG. 2, it is apparent how calcium phosphate settles in the depths of the pore and is built up into to hydroxyl-apatite crystals 4. This process provides for a remineralization of the teeth.

FIG. 2b, in comparison, shows the remineralization with fluoride as a catalyst in the case of a pH that slightly varies over time within the neutral range. Due to the high degree of mineral-oversaturation of the saliva in the neutral range, the process of the crystal formation occurs predominantly on the enamel surface; because the precipitated amount is proportional to the duration of the precipitation, whereas the diffusion time increases with the square of the diffusion path. Because of the precipitation along the path into the tooth, the diffusion flow to deeper layers is thinned out. The deeper layers are reached by less mineral. At the edge of the pore, hydroxyl-apatite crystals 4 form in the shape of a cap.

Presented below are some examples for possible compositions of melts with neutral and acidic pH. The following chemicals were used in all examples:

| | | |
|---|---|---|
| Calcium lactate | calcium pentahydrate | Fluka 21175 |
| Calcium gluconate | calcium-D-gluconate | Fluka 21142 |
| | monohydrate | |
| Calcium acetate | calcium acetate hydrate | Merck 1.09325 |
| Magnesium chloride | magnesium-chloride | Merck 1.05833 |
| | hexahydrate | |
| Magnesium lactate | magnesium-L-lactate hydrate | Fluka 63097 |
| Magnesium gluconate | magnesium-D-gluconate | Fluka 63106 |
| | hydrate | |
| Magnesium acetate | magnesium acetate | Merck 1.05819 |
| | tetrahydrate | |
| Gluconic acid | (50%) | Merck 8.22057 |
| Malic acid | | Merck 1.00382 |
| Citric acid | | Merck 8.18707 |

### EXAMPLE 1

### pH-Neutral Melt with Calcium Lactate

| | |
|---|---|
| 23.16 g | calcium lactate |
| 16.84 g | calcium gluconate |

at room temperature yields a bright, firm to ductile melt with 2.54 mol Ca/kg melt (corresponding to 101 g Ca/kg) with a water content of approximately 25% (w/w).

### EXAMPLE 2

### Neutral Melt with Calcium-Magnesium Lactate/Gluconate/Chloride

| | |
|---|---|
| 10.23 g | calcium lactate |
| 29.77 g | calcium gluconate |
| 10.00 g | magnesium chloride |

at room temperature yields a bright, firm to ductile melt with 1.92 mol Ca/kg melt (corresponding to 76.8 Ca/kg) and 0.95 mol magnesium/kg melt (corresponding to 23.1 g magnesium/kg).

### EXAMPLE 3

### pH-Neutral Melt with Calcium and Magnesium at a Ratio of 3:1 (w/w)

| | | |
|---|---|---|
| 2.82 | g | calcium lactate |
| 12.29 | g | calcium gluconate |
| 2.89 | g | calcium acetate |
| 0.99 | g | magnesium lactate |
| 6.05 | g | magnesium gluconate |
| 1.92 | g | magnesium acetate |

at room temperature yields a bright, firm to ductile melt with 1.67 mol Ca/kg melt (corresponding to 67 g Ca/kg) and 0.83 mol magnesium/kg melt (corresponding to 21 g magnesium/kg.)

### EXAMPLE 4

### pH-Neutral Melt with Calcium and Magnesium at a Ratio of 3:1 (w/w)

| | |
|---|---|
| 3.25 g | calcium lactate |
| 9.44 g | calcium gluconate |
| 5.31 g | calcium acetate |
| 1.16 g | magnesium lactate |
| 4.74 g | magnesium gluconate |
| 3.39 g | magnesium acetate |

at room temperature yields a bright, firm to ductile melt with 2.01 mol Ca/kg melt (corresponding to 80 g Ca/kg) and 1.00 mol magnesium/kg melt (corresponding to 24.3 g magnesium/kg.) Water content 33% (w/w).

### EXAMPLE 5

### Acidic Melt with Calcium, Lactic Acid, Malic Acid and Gluconic Acid

| | | |
|---|---|---|
| 25.00 | g | calcium lactate. |
| 9.42 | g | gluconic acid |
| 1.61 | g | malic acid |

at room temperature yields a bright, firm to ductile melt with 2.73 mol Ca/kg melt (corresponding to 109 g Ca/kg).

### EXAMPLE 6

### Acidic Melt with Calcium, Lactic Acid, Malic Acid, Gluconic Acid and Citric Acid

| | | |
|---|---|---|
| 25.00 | g | calcium lactate |
| 9.42 | g | gluconic acid |
| 1.61 | g | malic acid |
| 2.31 | g | citric acid |

at room temperature yields a bright, firm to ductile melt with 2.45 mol Ca/kg melt (corresponding to 98 g Ca/kg). Water content approximately 27% (w/w).

The reagents are dissolved in as little water as possible at temperatures around the boiling point and evaporated by concentration until they have reached the desired viscosity. Application of a vacuum accelerates the process and produces better results.

1. A food additive as a concentrated additive for supplying the human metabolism with mineral nutrients, characterized in that
the mineral nutrients are a component of a salt hydrate melt in an ionized form, wherein
the salt hydrate melt is a salt-water-system and its water content corresponds to the coordination number of the most hydrated ion.

2. A food additive according to claim 1, characterized in that the mineral nutrients are calcium, magnesium, zinc, potassium, iodine, iron, phosphorus, sodium, cobalt, boron, selenium and/or lithium.

3. A food additive according to any of the above claims, characterized in that the mineral nutrients are present in the salt hydrate melt as salts of organic and/or inorganic acids.

4. A food additive according to any of the above claims, characterized in that at least one of the acid radicals of the organic acids lactic acid, gluconic acid, citric acid, acetic acid, malic acid, fumaric acid, valeric acid, ascorbic acid, cysteine, glutaric acid, or the acid radical of any other approved acidifier, or of their partially esterified derivatives, is contained therein as anions.

5. A food additive according to any of the above claims, characterized in that at least one of the acid radicals of the inorganic acids, such as chlorides, sulphates, phosphates, fluorides, carbonates, or their partially esterified derivatives, is contained therein as anions.

6. A food additive according to any of the above claims, characterized in that salts of inorganic and organic acids or their partially esterified derivatives are contained therein as a cation source.

7. A food additive according to any of the above claims, characterized in that its pH is in the neutral range and that calcium lactate, calcium gluconate, and/or magnesium lactate are contained therein.

8. A food additive according to any of the above claims, characterized in that its pH is in the acidic range and that gluconic acid, malic acid, citric acid or other acids that are approved for food use are contained therein.

9. A food additive according to any of the above claims, characterized in that calcium is contained in the compound in the form lactate, gluconate, malate and/or citronate.

10. A food additive according to any of the above claims, characterized in that magnesium is contained in the compound in the form of lactate and/or acetate.

11. A food additive according to any of the above claims, characterized in that its flavor is slightly bitter and that lactates are contained therein.

12. A food additive according to any of the above claims, characterized in that its flavor is strongly bitter and that calcium chloride and/or magnesium chloride are contained therein.

13. A food additive according to any of the above claims, characterized in that its flavor is slightly sweet with a slightly bitter aftertaste and that calcium acetate is contained therein.

14. A food additive according to any of the above claims, characterized in that its flavor is neutral and that magnesium gluconate or calcium gluconate is contained therein.

15. A food additive according to any of the above claims, characterized in that the specific weight percentage of mineral nutrients is very high and that chlorides, such as calcium chloride or magnesium chloride, are contained therein.

16. A food additive according to any of the above claims, characterized in that it is contained in toothpaste, mouthwashes, other oral hygiene products, lipsticks, other ointments or liquids to be applied to the lips, in orally or rectally administered medicinal drugs, or in other pills or suppositories.

17. A food additive according to any of the above claims, characterized in that it is applied to the inside of drinking straws or to the interior surfaces of drinking water dispensers, drinking water purification equipment, or machines for the production of ice cubes,
and/or
that it is admixable to the drinking liquid from a reservoir with a tubing connection to these surfaces.

18. A method for producing a food additive according to any of the above claims, characterized in that gluconic acid, lactic acid, citric acid, acetic acid, malic acid or another acid that is suitable for food products is used.

19. Use of a food additive according to any of the above claims, characterized in that it is added in the production of food products, non-essential foods, chewing gum, or other substances that are intended to temporarily remain in the oral cavity or on the lips, beverages, medicinal drugs, other pills or suppositories, oral hygiene products, or tooth care products, and/or that it is admixed to intermediate products that are intended for the same.

20. Use of a food additive according to any of the above claims, characterized in that
it is admixed in solid to liquid form in the production of feed products, to salt lick stones, medicinal drugs or other pills, capsules, suppositories, or any other substances that are orally or rectally administered to animals, or that it is admixed during the purification of drinking water.
